(19) United States
(12) Patent Application Publication
(10) Pub. No.: US 2026/0331778 A1
(43) Pub. Date: Oct. 22, 2026

(54) SYSTEM AND METHOD FOR STATIC METASURFACE BEAM SHAPING WITH MANUFACTURING-INVARIANT UNIT CELL DESIGN

(71) Applicant: Dell Products LP, Round Rock, TX (US)

(72) Inventors: Navjot Kaur Khaira, Manotick (CA); Tejinder Singh, Manotick (CA); Harpreet S. Narula, Austin, TX (US)

(73) Assignee: Dell Products LP, Round Rock, TX (US)

(21) Appl. No.: 19/181,097

(22) Filed: Apr. 16, 2025

(51) Int. Cl. H01Q 15/00; H01Q 1/38; H01Q 3/30; H01Q 15/14

(52) U.S. Cl. CPC H01Q 15/0086; H01Q 1/38; H01Q 3/30; H01Q 15/142

(57) ABSTRACT

A system and method for manufacturing tolerance agnostic metasurface unit cells on a metasurface. The information handling system may include a processor, memory, power source, and a chassis having at least one external surface with a passive metasurface unit cell array operatively coupled to the at least one external surface. The passive metasurface unit cell array includes a plurality of metasurface unit cells, each of the plurality of metasurface unit cells including a uniformly-sized resonating main body formed to be sized uniformly across the plurality of metasurface unit cells and having a phase-delay line formed to extend at different lengths from the uniformly-sized resonating main body to introduce a phase difference across the plurality of metasurface unit cells to generate an interference pattern for beamforming in a reflected radio frequency signal reflected off of the surface of the metasurface unit cell array.

### FIELD OF THE DISCLOSURE

The present disclosure generally relates to manufacturing and structures of metasurface unit cells of a metasurface unit cell array. More specifically, the present disclosure relates to a structure of a metasurface unit cell that includes a variable length phase-delay line formed with a uniformly-sized metasurface unit cell of a metasurface unit cell array that is used to relay wireless transmissions within a radio frequency (RF) environment.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of a software applications via one or more processing units and provide wireless or wired communications in embodiments herein.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system and a passive metasurface unit cell array comprising a plurality of passive metasurface unit cells each including a phase-delay line which may be of varied length according to an embodiment of the present disclosure;

FIG. 2 is a block diagram illustrating an information handling system and a passive metasurface unit cell array comprising a plurality of passive metasurface unit cells each including a phase-delay line which may be of varied length with the passive metasurface unit cell array operatively coupled to a surface of the information handling system according to another embodiment of the present disclosure;

FIG. 3A is a graphic diagram of a metasurface unit cell including a phase-delay line of a first length that may be formed within the passive metasurface unit cell array according to an embodiment of the present disclosure;

FIG. 3B is a graphic diagram of a metasurface unit cell including a phase-delay line of a second length that may be formed within the passive metasurface unit cell array according to another embodiment of the present disclosure;

FIG. 4 is a graphic diagram illustrating a perspective exploded view of a metasurface unit cell including a phase-delay line of the passive metasurface unit cell array according to an embodiment of the present disclosure;

FIG. 5 is a top view graphic diagram illustrating a magnified view of a metasurface unit cell including a phase-delay line from a passive metasurface unit cell array according to another embodiment of the present disclosure; and

FIG. 6 is a flow diagram of a method of manufacturing a metasurface unit cell array with individual metasurface unit cells each including phase-delay lines which may be of varying lengths according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting wireless network device to a receiving wireless network device allows for rapid data transmission and communication between multiple devices. Wireless network devices may include wirelessly enabled information handling systems, access point devices, or any computing device, such as internet of things (IoT) devices that are wirelessly capable. As data transmission requirements increase, the electromagnetic (EM) wavelengths (e.g., 5G technologies using 20 to 50 GHz wireless signals or other frequencies, or WiFi 6 signals at 2.4 GHz, 5 GHz or even 6 GHz) used to transmit these ever-increasing amounts of data are shortened and may benefit from extended range. Extending wireless transmission range is especially difficult in radio frequency (RF) environments where dense wireless communications occur, such as locations where large numbers of users of information handling systems congregate such as in cafes or libraries. Adding to these wireless communication issues, laptop-type or tablet information handling systems, for example, have designs that inadvertently reflect, absorb, or scatter those wireless electromagnetic (EM) waves leading to additional wireless communication issues.

In an attempt to alleviate these wireless communication issues, some wireless communication technologists may install an additional number of routers, switches, repeaters, or modems that extend the distance of wireless communication throughout an area. However, this increases the costs associated with creating a wireless communication network in a radiofrequency environment due to the increased number and complexity of hardware components and ongoing operation costs. Therefore, there is a need to optimize wireless communications within an RF environment with each laptop-type information handling system or other wireless information handling system interacting with those EM waves of radiofrequency signals from an access point such that their interaction may optimize their own wireless performance and coexist seamlessly in a wireless-rich environment.

The inclusion of metasurfaces unit cell arrays within the RF environment helps to alleviate these issues. These metasurface unit cell arrays include a plurality of metasurface unit cells with resonating structures formed on a dielectric surface whose dimensions or geometry may be altered or varied across the metasurface unit cells in order to introduce phase shifting variations across the surface of the metasurface unit cell array. Indeed, the phase-shifting profile may create phase shifts in the incoming RF signals such that constructive and/or destructive interference is created so that a reflected EM lobe may be directed in one or more directions off of the surface of the metasurface unit cell array and with directional gain in the radiofrequency signals. The sizes of the various resonant structures formed at the metasurface unit cells may be of dimensions and spacing such that non-linear phase variations may be introduced because of the varied sizes of the resonant structures on the metasurface unit cells which may limit or restrict operating bandwidths across the metasurface unit cell arrays. Further, the fabrication of each of the individual, different sized resonant structures on the dielectric substrate of the metasurface unit cells requires significant manufacturing precision in order to maintain uniformity across the individual metasurface unit cells fabricated. At present, this high precision uniformity across the metasurface unit cells may not be achieved resulting in a metasurface unit cell array with a non-linearity of the phase profile thereby restricting the operational bandwidth of the metasurface unit cell array or may require very expensive manufacturing processes. This leads to variations in RF transmission losses across the metasurface unit cell array.

The present specification, therefore, describes an information handling system that includes a passive metasurface unit cell array operatively coupled to the surface of the information handling system. In an embodiment, the information handling system may include a processor, memory, power source, and a chassis having at least one external surface. In an embodiment, the information handling system may include a passive metasurface unit cell array operatively coupled to the at least one external surface of the information handling system. The passive metasurface unit cell array may include a plurality of metasurface unit cells. Each of the plurality of metasurface unit cells may include resonant structures formed from a resonating main body sized uniformly across the plurality of metasurface unit cells, but having different lengths for a phase delay line or tail extending from the resonating main body. Further, each of the plurality of metasurface unit cells includes a phase-delay line or tail, of varying lengths, formed to extend from an aperture notch in one side of the uniformly-sized resonating main body and extending a length from the resonating main body to introduce different amounts of phase difference among the plurality resonant structures for the metasurface unit cells. The arrangement of passive metasurface unit cells with uniform resonating main bodies and varying lengths of phase-delay lines or tails are used to generate an interference pattern in a reflected radio frequency (RF) signal reflected off of the surface of the passive metasurface unit cell array.

In an embodiment, each of the resonating bodies may be formed into a square or rectangular metal resonating main bodies. In an embodiment, each of the resonating bodies may be formed into any geometrical shape such as a triangle, a circle, a ring, and the like. The uniformity of the resonating main bodies simplifies the manufacture of these resonating structures deposited on the dielectric substrate of the metasurface unit cell array. Each of the phase-delay lines for the metasurface unit cells may extend out from the resonating main body like a tail of conductive material and wrap around a portion of the perimeter of the resonating main body to impart different amounts of phase difference by the resonating structure of that metasurface unit cell. The phase-delay lines also wrap around the resonating main body, but are electrically separate, to keep each metasurface unit cell compact. The dimensions of the resonating main body may be selected to be able to reflect a band of RF signals such as those of a 28 GHz frequency. The phase-delay lines may be trimmed or formed according to required different lengths across the metasurface unit cells to achieve the phase difference for phase-shift to be imparted by each of those metasurface unit cells to the reflected radiofrequency signal from across the passive metasurface unit cell array.

In one embodiment, multiple sizes of resonating main bodies may be incorporated into the passive metasurface unit cell array. In an example embodiment, the plurality of metasurface unit cells may include a first sized resonating main body dimensioned to reflect a first band of RF signals and a second sized resonating main body dimensioned to reflect a second band of RF signals. This allows, in an example embodiment, for multiple RF bands to be reflected off of the surface of the passive metasurface unit cell array while keeping the formation of the resonating main bodies uniform for portions of the passive metasurface unit cell array designated to each RF band.

Thus, the presently-described metasurface unit cell array of embodiments herein provides for an easily fabricated passive metasurface unit cell array. The fabrication may be streamlined by having uniform or near-uniform resonating main bodies with trimmable phase-delay lines or tails used to customize the phase shift at any given metasurface unit cell. In an embodiment, during the manufacturing process of the passive metasurface unit cell array and in order to create a specific phase delay pattern across the surface of the passive metasurface unit cell array. The lengths of each of the phase-delay lines may be formed to reflect the RF signals at a different phase shift relative to neighboring metasurface unit cells such that the phase delay pattern can be created for constructive or destructive interference patterns in the reflected radiofrequency signal. This allows the passive metasurface unit cell array to be used to beamform any reflected RF signal in a specific direction such as towards a receiving device and to impart gain in the radiofrequency signal in that direction.

Additionally, the passive metasurface unit cell array described herein allows for variability in distance between the individual metasurface unit cells. This distance variability may be in either or both the x-direction or y-direction along the plane of the passive metasurface unit cell array when the metasurface unit cells are arranged in columns and rows. This is advantageous to the designers and manufacturers of the passive metasurface unit cell array by allowing the designers to create RF beam variations without redesigning the entire layout of the metasurface unit cells of the passive metasurface unit cell array. This reduces research and develop time, design time, and compute time needed to create an entire new design of the passive metasurface unit cell array.

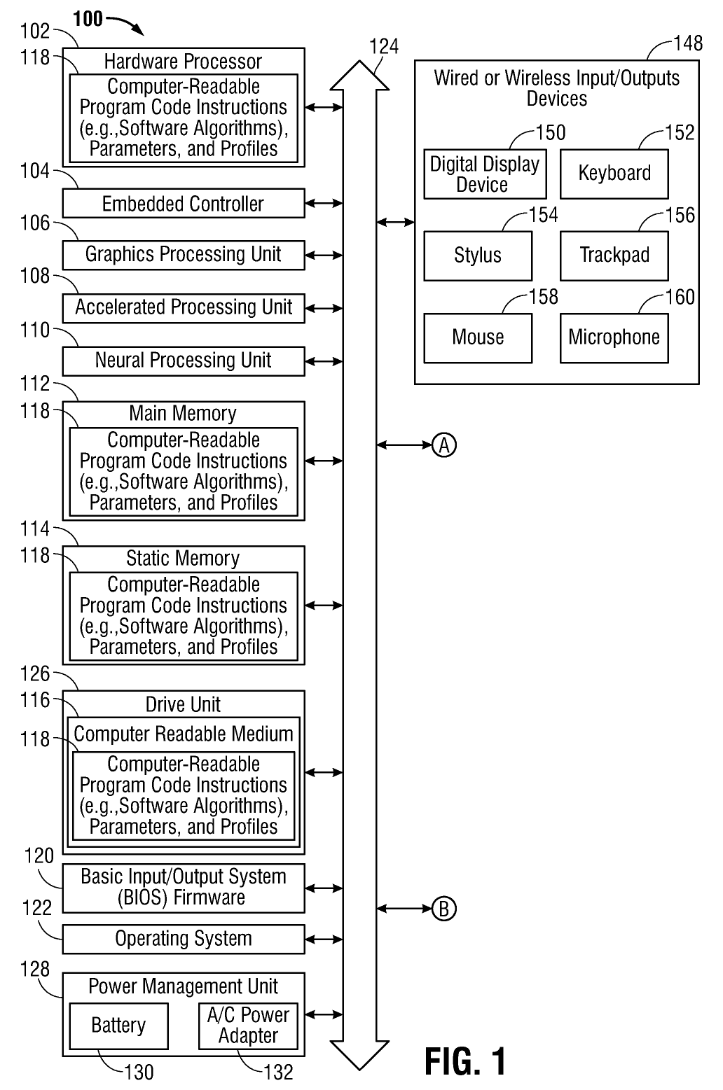

Turning now to the figures, FIG. 1 illustrates an information handling system 100 similar to the information handling systems according to several aspects of the present disclosure that may operate as a source or target radiofrequency wireless network device for use with the metasurface unit cell array of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or passive memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in passive memory 114, main memory 112, or drive unit 126 may be involved in invoking such computer-readable program code instructions to main memory 112 according to embodiments herein. Additional components of the information handling system 100 may include one or more storage devices such as passive memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, passive memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

The information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and one or more antennas 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems. In the context of the present disclosure the one or more antennas 140 may include one or more WiFi antennas operating at 2.4 GHz, 5 GHz, and/or 6 GHz frequencies, one or more Bluetooth antennas, and one or more 5G new radio (5G-NR) antennas that operate at Frequency Range 1 (FR1) (which includes sub-7 GHz frequency bands and those from 410 MHz to 7125 MHz0 and Frequency Range 2 (FR2) (which includes frequency bands from 24.25 GHz to 71.0 GHz frequency bands) for wireless communications via radiofrequency signals in a radiofrequency environment.

In other embodiments, the wireless interface device 134 with its radio 136, RF front end 138 and antennas 140 are used to communicate with a WWAN or and WLAN which may each include an AP 144 or base station 146 used to operatively couple the information handling system 100 to a network 142 via the wireless interface adapter 134 in a radiofrequency environment. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. The receiver device 170 may be any other device and may include the AP 144, the base station 146, or any other computing device described herein. Additionally, the information handling system 100 and receiver device 170 may be capable of transmitting wireless data using, for example, EM waves of radiofrequency signals that include 5G mm wave lengths such as those included within the 20-50 GHz range or WiFi wavelengths such as 2.4 GHz, 5 GHz, 6 GHz or others to be used with later versions of WiFi.

In an embodiment, the wireless interface adapter 134 may operate in accordance with any wireless data communication standards. To communicate with a wireless local area network and/or the receiver device 170, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and passive memory 114 may also contain a computer-readable medium for storage of one or more sets of machine-readable program code instructions, parameters, or profiles 118 described herein. The disk drive unit 126 or passive memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the passive memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as passive RAM (SRAM), dynamic RAM (DRAM), non-volatile RAM (NV-RAM), or the like, read only memory (ROM), another type of memory, or a combination thereof. Passive memory 114 may contain computer-readable medium (not shown), such as NOR or NAND flash memory in some example embodiments. The applications and associated APIs, for example, may be stored in passive memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may include a metasurface unit cell array 162 also referred to herein as a “metasurface” or “passive metasurface unit cell array.” In an embodiment, the metasurface unit cell array 162 is a passive metasurface unit cell array 162 that does not require power to operate as described herein. In an embodiment, the metasurface unit cell array 162 may be affixed to, formed onto, or embedded in a display chassis cover of the laptop-type information handling system 100 such as the A-cover of a laptop type information handling system or the back of a tablet type information handling system. The A-cover may include a top portion of the lid of the laptop-type information handling system 100 housing an integrated digital display device 150, for example. The placement of the metasurface unit cell array 162 on the A-cover of the laptop-type information handling system 100 or the back of a tablet-type information handling system 100 may allow for the enhancement of wireless coverage within an area of a radiofrequency environment. As described herein, the metasurface unit cell array 162 may be used to redirect incoming electromagnetic (EM) waves of radiofrequency signals with enhancements of those radiofrequency signals in directionality and gain in one or more of a plurality of directions to extend the wireless coverage of a network device such as an AP 144 or a base station 146. In another embodiment, the metasurface unit cell array 162 may be affixed to a surface within the radiofrequency environment and serve as a standalone device that may be used to relay wireless RF transmissions by reflecting those wireless RF transmissions off of its surface.

In an embodiment, the metasurface unit cell array 162 may include an array of metasurface unit cells 164-1 through 164-6. Each metasurface unit cells 164-1 through 164-6 may include a resonating structure that is sized of a dimension or spaced such that it resonates when the resonating structure interacts with a RF signal incident to the surface of the metasurface unit cell array 162. In an embodiment of the present disclosure, these resonating structures may include a uniform-sized resonating main body 168-1 through 168-6 with a phase-delay line 166-1 through 166-6, that may have an easily-adjusted length, operatively coupled to the resonating main body 168-1 through 168-6. For example, metasurface unit cell 164-1 may include a uniform-sized resonating main body 168-1 with a phase-delay line 166-1 or tail that may be of a first length. Metasurface unit cell 164-2 may include a uniform-sized resonating main body 168-2 with a phase-delay line 166-2 or tail that may be of a second length. Metasurface unit cell 164-3 may include a uniform-sized resonating main body 168-3 with a phase-delay line 166-3 or tail that may be of a third length. Metasurface unit cell 164-4 may include a uniform-sized resonating main body 168-4 with a phase-delay line 166-4 or tail that may be of yet another length or a repeat of a previous recited length. Metasurface unit cell 164-5 may include a uniform-sized resonating main body 168-5 with a phase-delay line 166-5 or tail that may be of yet another length or a repeat of a previous length. Metasurface unit cell 164-6 may include a uniform-sized resonating main body 168-6 with a phase-delay line 166-6 or tail that may be of yet another length or a repeat of a previous length. It is contemplated that the phase-delay lines or tails may be varied at three different lengths which are used across the metasurface unit cell array 162 to create a desired phase-shift profile. In other embodiments, the phase-delay lines or tails may be varied at any number of different lengths used across the metasurface unit cell array 162 to create a desired phase-shift profile.

The resonating main body 168-1 through 168-8 and phase-delay line 166-1 through 166-8 are formed of conductive material, such as metal, on a dielectric substrate in some embodiments. It is appreciated that the number of metasurface unit cells 164-1 through 164-6 may include more or fewer than the number of metasurface unit cells 164-1 through 164-6 shown in FIG. 1. In an embodiment, the metasurface unit cells 164-1 through 164-6 may be arranged on the surface of the metasurface unit cell array 162 in columns and rows. In an embodiment, the metasurface unit cells 164-1 through 164-6 may be placed at a distance from each other. This distance between each neighboring metasurface unit cells 164-1 through 164-6 may be selected based on the incident RF signals being reflected off of the surface of the passive metasurface unit cell array 162 in that the spacing dimension may be sized relative to the wavelengths of the expected RF signals being reflected in some embodiments herein.

In an embodiment, each of the resonating main bodies 168-1 through 168-6 of each of the metasurface unit cells 164-1 through 164-6 may be formed onto a dielectric substrate in a uniform or generally uniform size according to the RF signal to be reflected from the surface of the metasurface unit cell array 162. Thus, in an example embodiment, each of the resonating main bodies 168-1 through 168-6 may be formed into a square shape and be sized to be 1.88 mm by 1.88 mm in order to reflect a 28 GHz RF signal. It is appreciated, however, that any dimensions of the resonating main bodies 168-1 through 168-6 may be selected in order to reflect any frequency/wavelength of radiofrequency signal for wireless communications in a radiofrequency environment. In an embodiment, the plurality of metasurface unit cells 164-1 through 164-6 that form the metasurface unit cell array 162 may include a first portion of resonating structures having a first sized resonating main body 168-1 through 168-6 that is sized to reflect a first band of RF signals and a second portion of resonating structures having a second sized resonating main body 168-1 through 168-6 to reflect a second band of RF signals. This allows the metasurface unit cell array 162 to reflect, for example, 28 GHz frequencies and 5 GHz frequencies in some embodiments.

It is appreciated that metasurfaces are typically made with differing sizes of resonant structures such as forming multiple-sized squares on a single metasurface unit cell to obtain varied phase shift effects in a reflected RF signal. However, that the size of the resonant structures for depositing conductive material, such as metal, at those dimensions consistently may yield variance due to the processes used during the manufacturing process (usually = or – 10% variance). For example, this manufacturing process may include additive manufacturing that implements masks to form the different-sized resonant structures. Although there is a level of accuracy in this process, a variance of 0.6 mm or even 2 mm may significantly affect the ability of forming those different-sized structures for any given metasurface unit cell causing non-linearity of phase shift profiles. This non-linearity of the phase profiles among the resonant structures restricts the operational bandwidth of the metasurface unit cell array 162 limiting the ability of the metasurface unit cell array 162 to reflect the intended RF signal. Additionally, varied-sized resonant structures can introduce high insertion loss due to increased material usage during manufacture, as well as impedance mismatch impacting the use of the metasurface unit cell array 162 in resonating at the specific frequency. Even further, the irregularity in the manufactured size of each resonant structures may result in the inability to rely on the infinite array approximation for the metasurface unit cell array 162 resulting in less predictable RF signal reflection properties of the metasurface unit cell array 162.

Embodiments of the present disclosure utilize a design of resonant structures with uniform-sized resonating main bodies 168-1 through 168-6 for metasurface unit cells 164-1 through 164-6 to substantially simplify the manufacturing process of depositing conductive material for these resonating main bodies 168-1 through 168-6 on a substrate and reducing the variation and non-linearity, reducing material loss during manufacture, avoiding, impedance mismatch and the like. Reduced manufacturing complexity remains true when just two sizes or just a few sizes of resonating main bodies 168-1 through 168-6 are used to accommodate a couple of frequency bands by the metasurface unit cell array 162. In order to alleviate these issues with the formation of a vast array of variable-sized resonant structures (e.g., due to manufacturing intolerances), uniformly sized resonating main bodies 168-1 through 168-6 also include a phase-delay line 166-1 through 166-6 that are easily different in length to provide desired phase-shift profiles across the metasurface unit cells in a particular radiofrequency signal band. The phase-delay lines 166-1 through 166-6 and uniform-sized resonating main bodies 168-1 through 168-6 may enable a linear phase profile across the metasurface unit cell array 162 due to simplicity to achieve precision in manufacturing for achieving intended phase-delay profiles. These phase-delay lines 166-1 through 166-6 do this by altering, during manufacturing, the length of each of the individual phase-delay lines 166-1 through 166-6 associated with appropriate resonating main bodies 168-1 through 168-6 within the metasurface unit cell array 162. In an embodiment, the length of individual phase-delay lines 166-1 through 166-6 may, depending on the manufactured length used, increase or decrease the total path length that the incident RF signals are to travel before re-radiation or reflection from off of the surface of each metasurface unit cell 164-1 through 164-6 of the metasurface unit cell array 162. By adjusting the length of the phase-delay lines 166-1 through 166-6, the phase shift can be precisely tuned across the plurality of metasurface unit cells 164-1 through 164-6 to manipulate the reflected RF signals such that a particular phase shifting profile across the metasurface unit cell array 162. This phase shift profile, via variations of lengths of individual phase-delay lines 166-1 through 166-6 at each individual metasurface unit cell 164-1 through 164-6, may be used to direct the reflected RF signal (e.g., beamsteer) and, in some embodiments, and impart gain to a directional lobe of the RF signal thereby extending the distance of transmission by the metasurface unit cell array 162. In an embodiment, a longer phase-delay line 166-1 through 166-6 introduces a greater phase shift, which can be engineered to create phase discontinuities across the metasurface unit cell array 162 for specific reflection angles to generate constructive or destructive interference among signals reflected across the plurality of metasurface unit cells 164-1 through 164-6. It also follows that a shorter phase-delay line 166-1 through 166-6 introduces a relatively shorter phase shift in the reflected RF signal. Thus, instead of relying on the geometric sizing of the resonant structures with difficult variations to manufacture, each of the metasurface unit cells 164-1 through 164-6 employ uniformly-sized resonating main bodies 168-1 through 168-6 with a specific length of a phase-delay line 166-1 through 166-6 to create a phase shift at any given metasurface unit cell 164-1 through 164-6.

It is appreciated that linear phase profile created through the use of the phase-delay lines 166-1 through 166-6 with uniformly-sized resonating main bodies 168-1 through 168-6 for the metasurface unit cells 164-1 through 164-6 is desirable because it allows simplified manufacture with precise control and manipulation of the electromagnetic wavefront across the metasurface unit cell array 162, leading to improved beamforming and beam steering capabilities at a lower cost. The metasurface unit cells 164-1 through 164-6 with uniformly-sized resonating main bodies 168-1 through 168-6 and phase-delay lines 166-1 through 166-6 having easily manufactured different lengths result in improved bandwidth, accurate phase control, better impedance matching and improved overall efficiency in design and manufacture of the metasurface unit cell array 162. The metasurface unit cells 164-1 through 164-6 with their uniformly-sized resonating main bodies 168-1 through 168-6 and phase-delay lines 166-1 through 166-6 described herein also offer more uniform distribution ion of losses throughout and help to maintain a more consistent and regular structure within the metasurface unit cell array 162.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

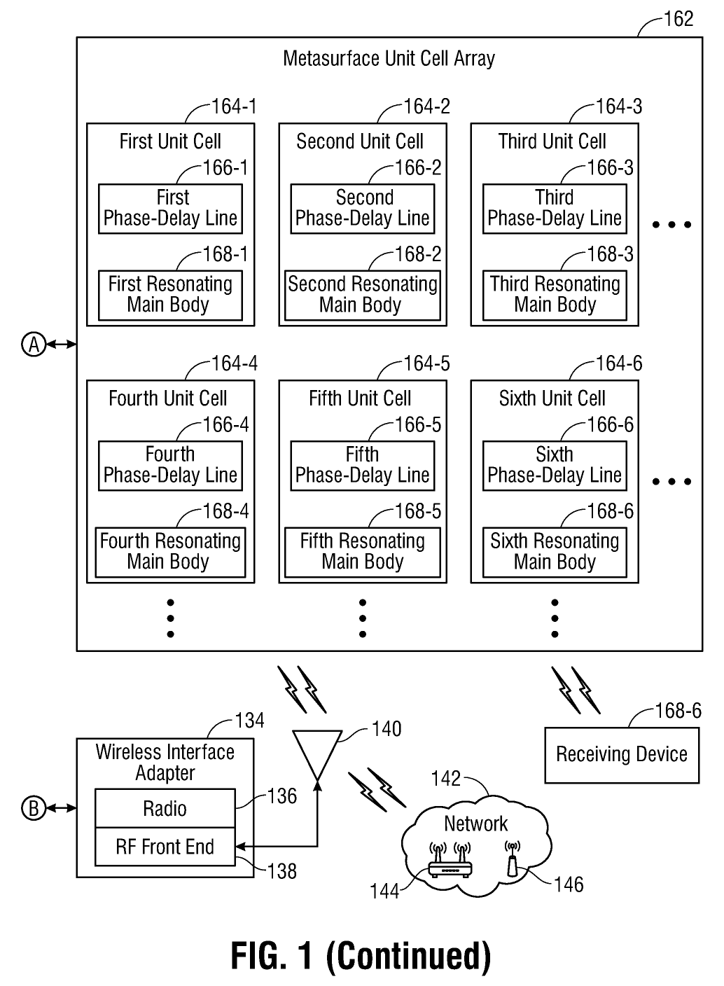

FIG. 2 is a block diagram illustrating an information handling system 200 with an operatively-coupled passive metasurface unit cell array 262 comprising a plurality of passive metasurface unit cells 264-1 through 264-6 each including a uniform-sized resonating main body 268-1 through 268-6 and phase-delay line 266-1 through 266-6 according to another embodiment of the present disclosure. As described herein, the information handling system 200 may be a laptop-type information handling system 200 that includes a lid portion 283 such as part of a display chassis for housing a digital display device 250. This lid portion 283 may be one location on the surface of the information handling system 200 where the metasurface unit cell array 262 may be placed. In an embodiment, the individual passive metasurface unit cells 264-1 through 264-6 of the metasurface unit cell array 262 may be formed directly on or embedded into the surface of the lid portion 283. In another embodiment, the metasurface unit cell array 262 may include a substrate onto which the passive metasurface unit cells 264-1 through 264-6 are placed on and the metasurface unit cell array 262 may be affixed to the surface of the lid portion 283. In yet another example embodiment, the metasurface unit cell array 262 may be formed into a protective case which may be coupled to the lid portion 283.

It is appreciated, however, that instead of the metasurface unit cell array 162 being affixed to a surface of the information handling system 200 as shown in FIG. 2, the or a metasurface unit cell array 162 may be affixed to a surface within the RF environment. This may allow the metasurface unit cell array 262 to operate within an RF environment where RF signals may be relayed and reflected off of the surface of the passive metasurface unit cell array 262 thereby extending the distance of transmission of these RF signals. In yet another embodiment, the passive metasurface unit cell array 262 may be affixed to both the surface of the information handling system 200 as well as to other surfaces within the RF environment.

As shown in FIG. 2, the laptop-type information handling system 200 includes a keyboard 252 for the user to provide input to the information handling system 200. Still further, the information handling system 200 may include a digital display device 250 for the user to be presented with visual output from the information handling system 200.

In an embodiment, the metasurface unit cell array 262 may include an array of metasurface unit cells 264-1 through 264-6. Each metasurface unit cells 264-1 through 264-6 may include a resonating structure that resonates when the resonating structure interacts with a RF signal incident to the surface of the metasurface unit cell array 262. In an embodiment, these resonating structures may include a uniformly-sized resonating main body 268-1 through 268-6 with a phase-delay line 266-1 through 266-6 having varied lengths operatively coupled to the uniformly-sized resonating main body 268-1 through 268-6. The size dimension of the uniformly-sized resonating main body 268-1 through 268-6 may be selected for the anticipated wavelengths of frequency bands of radiofrequency signals to be used in the radiofrequency environment with the metasurface unit cell array 262. The varying lengths of the phase-delay lines 266-1 through 266-6 across the metasurface unit cells 264-1 through 264-6 may increase resonant edge lengths across the array of metasurface unit cells 264-1 through 264-6 for precise control of phase-shift profile across those metasurface unit cells 264-1 through 264-6.

It is appreciated that the number of metasurface unit cells 264-1 through 264-6 may include more or fewer than the number of metasurface unit cells 264-1 through 264-6 shown in FIG. 2. In an embodiment, the metasurface unit cells 264-1 through 264-6 may be arranged on the surface of the metasurface unit cell array 262 in columns and rows. In an embodiment, the metasurface unit cells 264-1 through 264-6 may be placed at a spacing distance from each other. This spacing distance dimension between each neighboring metasurface unit cells 364-1, 364-2 may be selected based on the incident RF signals being reflected off of the surface of the passive metasurface unit cell array 262 in some embodiments.

In an embodiment, each of the uniformly-sized resonating main bodies 268-1 through 268-6 of each of the may be formed onto a substrate in a uniform or generally uniform size according to the RF signal to be reflected from the surface of the metasurface unit cell array 262. Thus, in an example embodiment, each of the uniformly-sized resonating main bodies 268-1 through 268-6 may be formed into a square shape and be sized to be 1.88 mm by 1.88 mm in order to reflect a 28 GHz RF. It is appreciated, however, that any dimensions of the resonating main bodies 268-1 through 268-6 may be selected in order to reflect any frequency of wireless signal. In an embodiment, the plurality of metasurface unit cells 264-1 through 264-6 that form the metasurface unit cell array 262 may include a first sized resonating main body 268-1 through 268-6 that is sized to reflect a first band of RF signals and a second sized resonating main body 268-1 through 268-6 to reflect a second band of RF signals among groups of metasurface unit cells 264-1 through 264-6 across the metasurface unit cell array 262. This allows the metasurface unit cell array 262 to reflect, for example, 28 GHz frequencies and 5 GHz frequencies in some embodiments. It is appreciated that the uniformly-sized resonating main bodies 268-1 through 268-6 are simpler to manufacture avoiding wide variance that may occur due to the impression used during the manufacturing process in other types metasurface unit cell arrays with widely-varying resonant structure sizes, for example varied size square, rectangles, circles or the like at unit cells, and not employing the uniformly-sized resonating main bodies 268-1 through 268-6 with varying lengths of the phase-delay lines 266-1 through 266-6 across the metasurface unit cells 264-1 through 264-6.

In order to alleviate these issues with the uniformly-sized resonating main bodies 268-1 through 268-6 includes the phase-delay lines 266-1 through 266-6 that enable a linear phase profile across the metasurface unit cell array 262 with simpler manufacturing due to shunting, masking, or cutting lengths used for the phase-delay lines 266-1 through 266-6 formed and extending from the uniformly-sized resonating main bodies 268-1 through 268-6 of each of the metasurface unit cells 264-1 through 264-6. These phase-delay lines 266-1 through 266-6 do this by altering, during manufacturing, the length of each of the individual phase-delay lines 266-1 through 266-6 associated with appropriate resonating uniformly-sized resonating main bodies 268-1 through 268-6 within the metasurface unit cell array 262. In an embodiment, the length of individual phase-delay lines 266-1 through 266-6 may, depending on the manufactured length, increase or decrease the total path length or resonating edge that the incident RF signals are to travel before re-radiation or reflection from off of the surface of that particular metasurface unit cell 264-1 through 264-6 of the metasurface unit cell array 262. By adjusting the length of the phase-delay lines 266-1 through 266-6, the phase shift can be precisely tuned across metasurface unit cell 264-1 through 264-6 of the metasurface unit cell array 262 to manipulate the reflected RF signals such that a particular phase shifting profile across the metasurface unit cell array 262, via each individual metasurface unit cell 264-1 through 264-6, may achieve directionality and gain in the reflected RF signal. This is used to steer the reflected RF signal (e.g., beamsteer) and, in some embodiments, increase RF signal amplitude in a directional lobe or lobes of the reflected RF signal thereby extending the directions and distance of transmission of RF signals in the radiofrequency environment by the metasurface unit cell array 262. In an embodiment, a longer phase-delay line 266-1 through 266-6 introduces a greater phase shift, which can be engineered to create phase discontinuities across the metasurface unit cell array 262 for specific reflection angles. It also follows that a shorter phase-delay line 266-1 through 266-6 introduces a relatively shorter phase shift in the reflected RF signal. Thus, instead of relying on the geometric sizing of resonant structures on unit cells alone for phase shifting, the uniformly-sized resonating main bodies 268-1 through 268-6 of each of the metasurface unit cells 264-1 through 264-6 employ a specific length of a phase-delay line 266-1 through 266-6 to create a phase shift at any given metasurface unit cell 264-1 through 264-6. Further, the phase-delay lines 266-1 through 266-6 may extend and wrap around the uniformly-sized resonating main bodies 268-1 through 268-6, with at least some dielectric separation from the uniformly-sized resonating main bodies 268-1 through 268-6. In this way, the structure of each of the metasurface unit cells 264-1 through 264-6 may remain compact and not much larger than the dimensions of the uniformly-sized resonating main bodies 268-1 through 268-6 to provide for a more consistent and regular array structure of the metasurface unit cell array 262 providing even easier manufacturing. This more consistent and regular array structure of the uniformly-sized resonating main bodies 268-1 through 268-6 with compact, varying-length phase-delay lines 266-1 through 266-6 may also yield less variation reducing risk of phase-shift profile non-linearity and impedance mismatch in embodiments herein.

It is appreciated that linear phase profile created through the use of the varying-length phase-delay lines 266-1 through 266-6 is desirable because it allows for simpler manufacturing as well as precise control and manipulation of the electromagnetic wavefront across the resulting metasurface unit cell array 262, leading to improved beamforming and beam steering capabilities. The metasurface unit cells 264-1 through 264-6 with the uniformly-sized resonating main bodies 268-1 through 268-6 and varying-length phase-delay lines 266-1 through 266-6 improve bandwidth capabilities, accurate phase control, better impedance matching and improved overall efficiency in the manufactured metasurface unit cell array 262 as well as reducing costs. The metasurface unit cells 264-1 through 264-6 with their uniformly-sized resonating main bodies 268-1 through 268-6 and phase-delay lines 266-1 through 266-6 described herein also offer more uniform distribution ion of losses throughout and helps to maintain a more consistent and regular structure within the manufactured metasurface unit cell array 262.

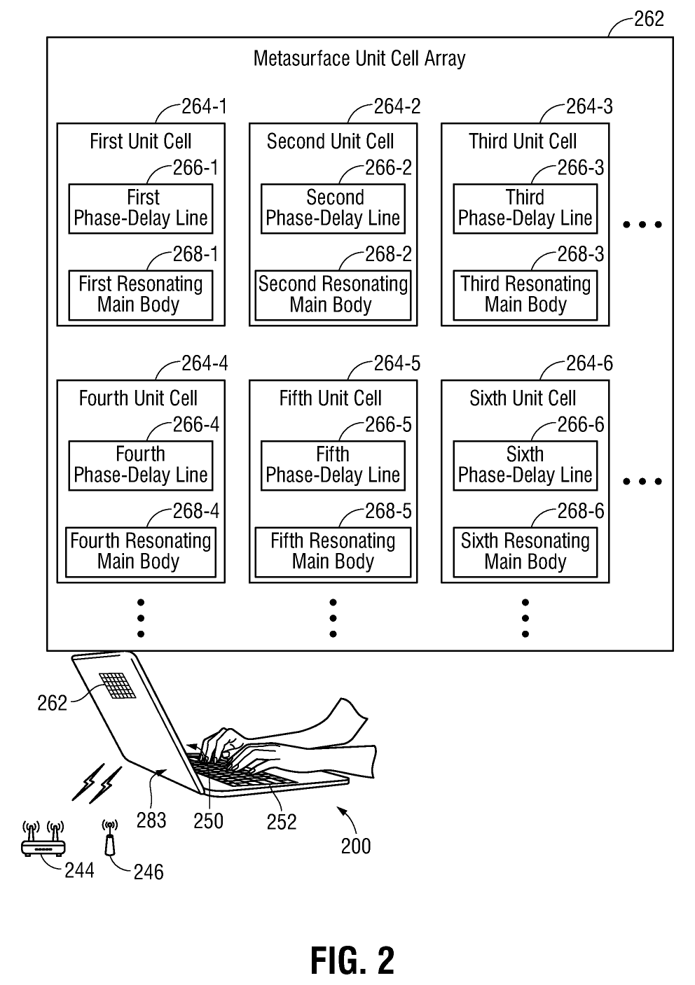

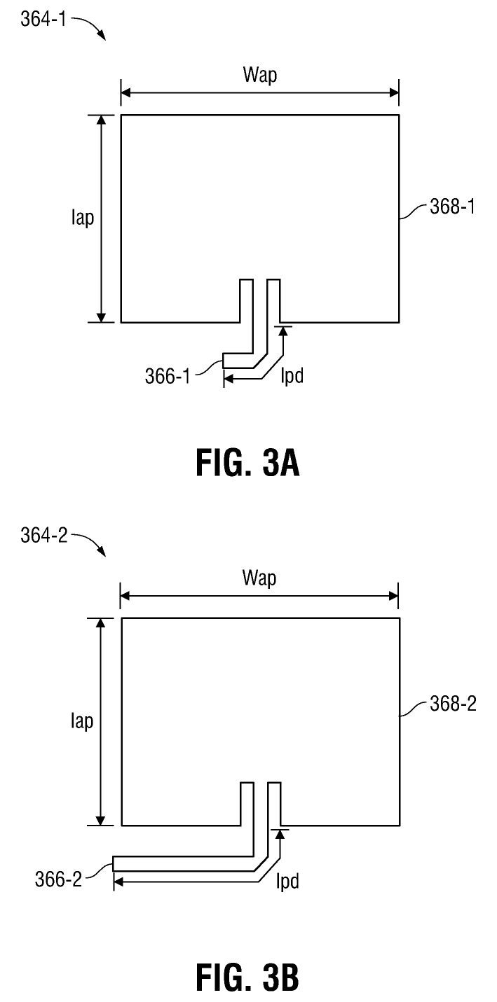

FIG. 3A is a graphic diagram of a metasurface unit cell 364-1 with a phase-delay line 366-1 that may be formed within the passive metasurface unit cell array according to an embodiment of the present disclosure. FIG. 3B is a graphic diagram of a metasurface unit cell 364-2 with a phase-delay line 366-2, having a different length than the phase-delay line 366-1 that may be formed within the passive metasurface unit cell array according to another embodiment of the present disclosure. It is appreciated that the metasurface unit cells 364-1, 364-2 may be two examples of a plurality of metasurface unit cells 364-1, 364-2 arranged within the passive metasurface unit cell array and, in an embodiment, arranged in rows and columns. It is appreciated that while phase-delay lines 366-1 and 366-2 show two different length options, three or more length options are contemplated for the metasurface unit cells 364-1, 364-2 in embodiments herein. In an embodiment, the metasurface unit cells 364-1, 364-2 may be arranged on the passive metasurface unit cell array at a distance from each other. This distance between each neighboring metasurface unit cells 364-1, 364-2 may be selected based on the wavelength of incident RF signals being reflected off of the surface of the passive metasurface unit cell array.

As described herein, each of the metasurface unit cells 364-1, 364-2 includes a uniformly-sized resonating main body 368-1, 368-2. The dimensions of the resonating main bodies 368-1, 368-2 may be chosen based on the wavelength RF signal band being reflected off of the surface of the passive metasurface unit cell array. As described herein, each of the uniformly-sized resonating main bodies 368-1, 368-2 of each of the metasurface unit cells 364-1, 364-2 may be formed onto a dielectric substrate having generally uniform dimensions, with a uniform length “lₐₚ” and a uniform width “wₐₚ”, selected according to the wavelength of the RF signal band of RF signals expected to be reflected from the surface of the metasurface unit cell array. In an example embodiment, each of the uniformly-sized resonating main bodies 368-1, 368-2 may be formed into a square shape and be sized to be 1.88 mm by 1.88 mm in order to reflect a 28 GHz RF. In other embodiments, the uniformly-sized resonating main bodies 368-1, 368-2 may be rectangular or of some other uniform shape for ease of formation on a dielectric substrate. In the embodiments shown in FIGS. 3A and 3B, a length “lₐₚ” and a width “wₐₚ” may be selected to resonate at a specific frequency or frequency band associated with the wavelengths of transmitted RF signals within the RF environment.

It is appreciated, however, that any dimensions of the uniformly-sized resonating main bodies 368-1, 368-2 may be selected in order to reflect any frequency band of the radiofrequency signals used for wireless communications in various embodiments herein such that the passive metasurface unit cell array may be designed for one, or even plural, specific radiofrequency bands used in a radiofrequency environment. In one embodiment, the plurality of metasurface unit cells 364-1, 364-2 that form the metasurface unit cell array may include a first sized resonating main body 368-1, 368-2 that is sized to reflect a first band of RF signals and a second sized resonating main body 368-1, 368-2 to reflect a second band of RF signals, for example. This allows distinct portions or interleaved metasurface unit cells 364-1, 364-2 of the metasurface unit cell array to reflect, for example, 28 GHz frequencies and 5 GHz frequencies or any other plurality of RF signals from different wireless communication bands in some embodiments. The present specification also contemplates that the uniformly-sized resonating main bodies 368-1, 368-2 may be any geometric shape including a triangle, a circle, and a ring among other shapes.

In order to alleviate those issues resulting from manufacturing intolerances used for metasurfaces using a multitude of the varied sizes for resonating structures, the uniformly-sized resonating main bodies 368-1, 368-2 each includes a phase-delay line 366-1, 366-2 formed to extend from an aperture notch in one side of the uniformly-sized resonating main bodies 368-1, 368-2. Again, the various lengths of any given phase-delay line 366-1, 366-2 operatively coupled to any given uniformly-sized resonating main body 368-1, 368-2 may be selected across a plurality of metasurface unit cells 364-1, 364-2 in a metasurface unit cell array based on a phase profile to be created on the passive metasurface unit cell array. The phase-delay lines 366-1, 366-2 may better enable a linear phase profile across the metasurface unit cell array such that predicable phase-shift adjustments may be made to generate directionality and gain in reflected RF signals in some example embodiments. These phase-delay lines 366-1, 366-2 accomplish this linear phase profile by altering, during manufacturing, the length “l_{pd}” of each of the individual phase-delay lines 366-1, 366-2 associated with appropriate uniformly-sized resonating main bodies 368-1, 368-2 of metasurface unit cells 364-1, 364-2 formed at particular locations relative to one another across the metasurface unit cell array. In an embodiment, the length (lₐₚ) of individual phase-delay lines 366-1, 366-2 may, depending on the manufactured length, increase or decrease the total path length that the incident RF signals are to travel and resonating edge length available before re-radiation or reflection from off of the surface of the metasurface unit cell array. By adjusting the length of the phase-delay lines 366-1, 366-2, the phase shift can be precisely tuned to manipulate the phase shift imparted by each metasurface unit cell 364-1, 364-2 to the reflected RF signals such that a particular phase shifting profile across the metasurface unit cell array may be achieved to steer the reflected RF signal (e.g., beamsteer) and, in some embodiments, increase amplitude at a directional lobe of the RF signal thereby extending the distance of transmission by the metasurface unit cell array.

In an embodiment, a longer phase-delay line 366-2 such as that shown in FIG. 3B introduces a greater phase shift at that specific metasurface unit cell 364-2 which can be engineered to create phase discontinuities across the metasurface unit cell array for specific reflection angles. A shorter phase-delay line 366-1 such as that shown in FIG. 3A introduces a relatively shorter phase shift in the reflected RF signal. Thus, instead of relying on the geometric sizing of the entire resonant structure, such as the, each of the metasurface unit cells 364-1, 364-2 employ uniformly-sized resonating main bodies portion 368-1, 368-2 with a specific length of a phase-delay line 366-1, 366-2 at any given metasurface unit cell 364-1, 364-2 to create a tuned phase shift profile across the plurality of metasurface unit cells 364-1, 364-2.

Additionally, as shown in FIGS. 3A and 3B, the phase-delay lines 366-1, 366-2 may be formed extend out from an aperture notch in one side of the uniformly-sized resonating main bodies 368-1, 368-2 and wrap around a portion of the perimeter of the resonating main body. Because of the differing lengths of the phase-delay lines 366-1, 366-2 between those shown in FIGS. 3A and 3B, the distance that any given phase-delay line 366-1, 366-2 wraps around their respective resonating main bodies 368-1, 368-2 may vary. Further, the different lengths of phase-delay lines 366-1, 366-2 may be formed extending from an aperture notch in one side of the uniformly-sized resonating main bodies 368-1, 368-2 such that more length variability is available to be adjusted in manufacturing while taking up even less space per metasurface unit cell 364-1, 364-2. Nonetheless, this wrapped length of phase-delay line 366-1, 366-2 around, but without touching, the respective uniformly-sized resonating main bodies 368-1, 368-2 maintains a largely uniform, compact metasurface unit cell 364-1, 364-2 such that the metasurface unit cell array is more uniform in layout and compact in size, easier to manufacture, and subject to less variation and potential impedance mismatches or other problems. It is appreciated that the phase-delay line 366-1, 366-2 may extend directly out from the resonating main body 368-1, 368-2 in one example embodiment. However, by wrapping the phase-delay line 366-1, 366-2 around the resonating main body 368-1, 368-2, space is conserved on the surface of the passive metasurface unit cell array thereby allowing for more metasurface unit cells 364-1, 364-2 to be compactly formed onto the surface of the passive metasurface unit cell array and with greater uniformity with reduced risk of manufacturing variations and attendant issues.

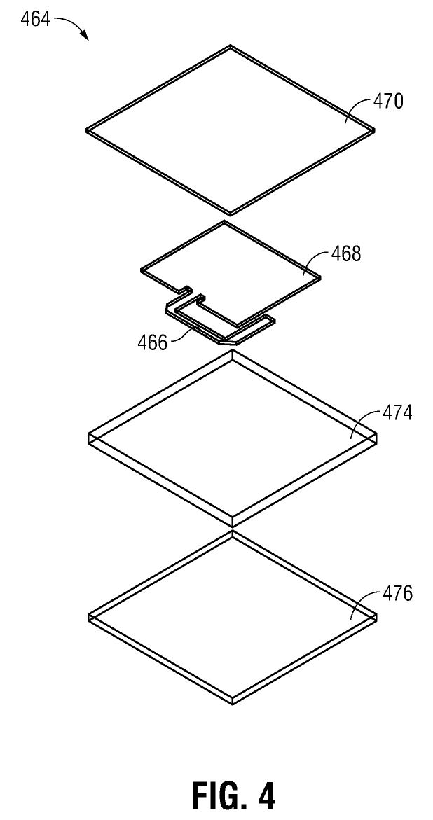

FIG. 4 is a graphic diagram illustrating an exploded view of a metasurface unit cell 464 that may be used in a passive metasurface unit cell array according to an embodiment of the present disclosure. As described herein, the metasurface unit cells 464 of the passive metasurface unit cell array may be formed into a surface of the information handling system such as that shown in FIG. 2, for example. In other embodiments, the metasurface unit cells 464 of the passive metasurface unit cell array may be formed into a surface including a panel having a dielectric substrate 474.

In an embodiment, the metasurface unit cell 464 may include a uniformly-sized resonating main body 468 similar to those uniformly-sized resonating main bodies described in connection with FIGS. 3A and 3B. Again, the uniformly-sized resonating main body 468 may include a phase-delay line 466 that extends away from the resonating main body 468 and wraps around a perimeter of the resonating main body 468. In the example of FIG. 4, the phase-delay line 466 shows an embodiment with a longer option of the phase-delay line 466 wrapping further around a side of the uniformly-sized resonating main body 468. In an embodiment, the uniformly-sized resonating main body 468 and phase-delay line 466 may be made of a metal such as copper. In an embodiment, the uniformly-sized resonating main body 468 and phase-delay line 466 may be formed using a masking process. It is appreciated, however, that any additive or subtractive manufacturing process may be implemented in order to form the conductive material of the uniformly-sized resonating main body 468 and phase-delay line 466 onto a dielectric substrate 474. The phase-delay line 466 may be formed of a uniform length at a longest option, such as shown, and each metasurface unit cell 464 modified by removing, snipping, or etching, a portion of the length of the phase-delay lines 466 to a selected stub length in an embodiment. In other embodiments, the length of the phase-delay line 466 may be masked just at the desired stub length for each phase-delay line 466 when the metal is deposited for each metasurface unit cell 464 when forming the passive metasurface unit cell array on the dielectric substrate 474. Various other techniques may also be employed to vary the length of the phase-delay line 466 in embodiments herein.

The metasurface unit cell 464 may include, as a top surface, an RF transparent cover layer 470. The RF transparent cover layer 470 may be made of any radiofrequency transparent material such as glass or plastic. The RF transparent cover layer 470 may prevent a user from touching the resonating main body 468 and phase-delay line 466 thereby preventing damage to these elements of the metasurface unit cell 464.

As described, the uniformly-sized resonating main body 468 and phase-delay line 466 are formed onto a dielectric substrate 474. This dielectric substrate may be used to prevent electrical contact between the resonating main body 468/phase-delay line 466 and a metal backing layer 476. In an embodiment, the dielectric substrate 474 may be made of any dielectric material such as RO4000 Series (e.g., RO4350B, RO4003C) printed circuit board (PCB) manufactured by Rogers Corporation, silicone dioxide, or other PCB dielectric materials such as glass, metal oxides, or polytetrafluoroethylene (PTFE). The metal backing layer 476 may be made of a metal. In an embodiment, this metal may be copper or gold.

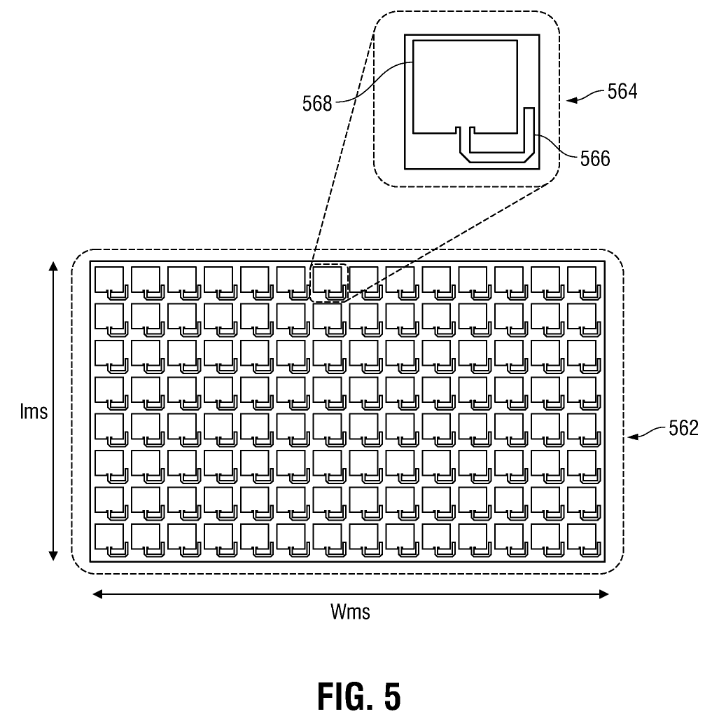

FIG. 5 is a graphic diagram of a magnified view of a metasurface unit cell 564 from a correlating passive metasurface unit cell array 562 made of a plurality of metasurface unit cells shown according to an embodiment of the present disclosure. The metasurface unit cell array 562 in the example shown in FIG. 5 includes an array of eight rows by fourteen columns of metasurface unit cells 564. Each of the metasurface unit cells 564 includes a resonating main body 568 and a phase-delay line 566 extending out of the resonating main body 568. Although FIG. 5 shows each phase-delay line 566 being approximately the same length, it is appreciated that the length of each of the phase-delay lines 566 of each resonating main bodies 568 may vary across the plurality of adjacent metasurface unit cells 564 in order to create a specific phase profile across the surface of the metasurface unit cell array 562 for the purposes of beamforming and amplitude gain in reflected RF signals off of the surface of the passive metasurface unit cell array 562.

As shown in FIG. 5, the eight rows of metasurface unit cells 564 may have a specific length “lₘₛ” and a specific width “wₘₛ.” In the embodiment where the length and width of the resonating main body 568 is 1.88 mm, the lₘₛmay be 1.5 cm. In this example embodiment, the fourteen rows may be 2.63 cm. Additionally, it is appreciated that that metasurface unit cell array 562 may comprise more or fewer than the number of metasurface unit cells 564 shown in FIG. 5 and, therefore, may increase the overall length (lₘₛ) and width (wₘₛ) of the metasurface unit cell array 562.

Although specific dimensions of the metasurface unit cell array 562 are presented in FIG. 5, it is appreciated that the distances between the metasurface unit cells 564 within the metasurface unit cell array 562 may vary depending on the radiofrequency band of radiofrequency signals to be reflected off of the surface of the metasurface unit cell array 562. These distances between formed metasurface unit cells 564 may be selected to alter and affect the formed beams of reflected radiofrequency signals off of the metasurface unit cell array. For example, each of the uniformly-sized resonating main bodies are formed into rows and columns across the metasurface unit cell array and evenly spaced apart at a spacing distance between the metasurface unit cells to adjust beamwidth of beamforming for reflected RF signals in embodiments herein. The distance of the spacing between the metasurface unit cells may be increased for wider beam width of directional beams of reflected radiofrequencies in a radiofrequency environment in an embodiment. Similarly, narrower spacing between the metasurface unit cells may yield narrower beam width of directional beams of reflected radiofrequencies in a radiofrequency environment in another embodiment. In yet other embodiments, each of the uniformly-sized resonating main bodies and phase-shift lines of metasurface unit cells formed into rows and columns across the metasurface unit cell array may be asymmetrically spaced apart across the rows or across the columns or both of the metasurface unit cell array to generate asymmetric beam shaping of beamforming for reflected RF signals in the radiofrequency environment. Further, the uniformly-sized resonating main bodies and phase-shift lines of metasurface unit cells formed into rows and columns across the metasurface unit cell array may be formed in rotational orientations to further impact the phase-shifting across plural metasurface unit cells and impact the beamforming and gain due to constructive or destructive interference patterns formed across the formed passive metasurface unit cell array in yet other embodiments herein.

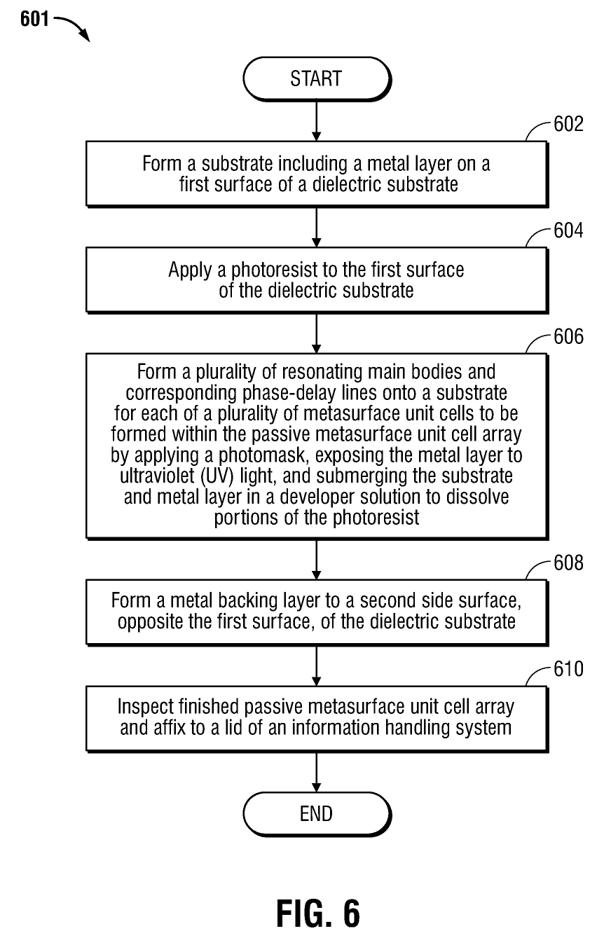

FIG. 6 is a flow diagram of a method 601 of manufacturing a metasurface unit cell array with individual metasurface unit cells each including a uniformly-sized resonating main body with a phase-delay line according to an embodiment of the present disclosure. The method 601 may be used to form any number of metasurface unit cells on a metasurface unit cell array and may include using any additive or subtractive process to form conductive uniformly-sized resonating main bodies with phase-delay lines of different lengths to generate an array of phase-shifting in a phase-shift pattern across the metasurface unit cells for beamsteering and amplitude gain in reflected RF signals. In an example embodiment, a masking manufacturing technique such as photolithography may be used to deposit conductive material, such as metal, of the conductive uniformly-sized resonating main bodies with phase-delay lines of different lengths to form the metasurface unit cells. However, the present specification contemplates the use of any appropriate manufacturing techniques to form the metasurface unit cells.

At block 602, the method 601 may include forming a dielectric substrate. In an embodiment, the dielectric layer may be made of dielectric material and includes a metal layer on a first surface of a dielectric substrate. As described herein, the metal layer may include any metal including copper or gold that may have been pre-deposited onto the first surface of the dielectric substrate. In an embodiment, the dielectric substrate may be made of any dielectric material such as RO4000 Series (e.g., RO4350B, RO4003C) printed circuit board (PCB) manufactured by Rogers Corporation, silicone dioxide, or other PCB dielectric materials such as glass, metal oxides, or polytetrafluoroethylene (PTFE). In an embodiment, the dielectric substrate layer may be cleaned with a solvent to remove contaminants for later processes in this manufacturing process and method 601 described herein.

At block 604, a photoresist is applied to the first surface of the dielectric substrate. This photoresist may be coated onto the metal layer to form a coating of photoresist that has a uniform thickness (e.g., 1-2 picometers). This may be used, along with forming a photomask as below, to form patterns if the conductive material.

At block 606, in an embodiment, a photomask in patterns of the conductive uniformly-sized resonating main bodies with phase-delay lines of different lengths may be applied to the layers may and backed to remove any solvents and solidify the photoresist layer over the metal layer to form the patterns of the conductive uniformly-sized resonating main bodies with phase-delay lines of different lengths. The method 601 may include forming a plurality of uniformly-sized resonating main bodies and corresponding phase-delay lines onto a substrate for each of a plurality of metasurface unit cells to be formed within the passive metasurface unit cell array by applying a photomask on photoresist and exposing the photomask to ultraviolet (UV) light. Upon submerging the substrate and metal layer with photomask in an etching developer solution or depositing the same thereon to dissolve portions of the photoresist or dissolve exposed portions depending on the type of photoresist used, the remaining pattern of metal not etched away or deposited on photoresist guide portions form precise conductive uniformly-sized resonating main bodies with phase-delay lines of different lengths to form the metasurface unit cells on the dielectric substrate. In some embodiments, no prior layer of metal may be pre-formed on the dielectric substrate and, instead, the photoresist may be formed in patterns on the dielectric substrate to be exposed to light in a photomask pattern to provide for a guide to create patterns for deposition of metal on the dielectric substrate.

With this process, accurate size and shape of the uniformly-sized resonating main bodies may be easily formed across the dielectric substrate of the metasurface unit cell array. Further, each uniformly-sized resonating main body may include the only variation being those different-lengths of phase-delay lines formed from the resonating main bodies as described herein in order to create the linear phase profile created through the use of the different lengths of phase-delay lines. This may only require adjustment of the masking used to create different length stubs of the phase-delay lines formed from the uniformly-sized resonating main body. As described in embodiments herein, the different lengths of phase-delay lines used across the metasurface unit cells formed according to the above are arranged across the passive metasurface unit cell with size and length to phase shift reflected radiofrequency signals across the plurality of metasurface unit cells to generate the desired beamsteering and amplitude gain according to embodiments herein.

At block 608, the metal backing layer may be formed onto the second side surface, opposite the first, of the dielectric substrate. Again, this metal layer may be deposited so as to coat the second surface of the dielectric layer and may be formed prior to forming the uniformly-sized resonating main bodies with different lengths of phase-delay lines.

Once the metasurface unit cell array is manufactured, the metasurface unit cell array may be inspected and affixed to a surface at block 610 in an embodiment. Thus, the metasurface unit cell array may be formed into or onto the surface of the information handling system. As described herein, a display chassis lid of an information handling system may be an optimal location for placement of the metasurface unit cell array such that redirected or reflected RF signals may be reflected away from the information handling system in plural directions in the radiofrequency environment and used by other devices within a wireless network. The passive metasurface unit cell array may be affixed with adhesive, snap fit into, embedded into, affixed with fasteners, or otherwise operatively coupled to or embedded into a surface of the information handling system according to embodiments herein. At this point, the method 601 may end.

The processes or steps and aspects of the operation of the embodiments herein, such as for FIG. 6, and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a processor, memory, power source, and a chassis having at least one external surface;
a passive metasurface unit cell array operatively coupled to the at least one external surface of the information handling system for reflecting radiofrequency (RF) signals in a radiofrequency environment comprising:
a plurality of metasurface unit cells, each of the plurality of metasurface unit cells including:
a uniformly-sized resonating main body formed of conductive material deposited on a dielectric substrate and sized uniformly across at least a portion of the plurality of metasurface unit cells; and
a phase-delay line of conductive material formed to extend from an aperture notch of the uniformly-sized resonating main body and extending a length from the uniformly-sized resonating main body to introduce a phase shift in RF signals incident on the metasurface unit cell, wherein different-length phase-delay lines are formed among the plurality of metasurface unit cells to generate an interference pattern in a reflected RF signal reflected off of the surface of the metasurface unit cell array for beamsteering in the radiofrequency environment.

2. The information handling system of claim 1 further comprising:
each of the uniformly-sized resonating main bodies formed into square metal uniformly-sized resonating main bodies arranged in rows and columns across the metasurface unit cell array.

3. The information handling system of claim 1, wherein each of the phase-delay lines extend out from the uniformly-sized resonating main body and wraps around a portion of the perimeter of the uniformly-sized resonating main body at different lengths across the metasurface unit cells.

4. The information handling system of claim 1, wherein the uniformly-sized resonating main body is dimensioned in length and width to reflect a wavelength band of the incident RF signals in the radiofrequency environment.

5. The information handling system of claim 1 further comprising:
the plurality of metasurface unit cells including:
a first uniformly-sized resonating main body dimensioned to reflect a first wavelength band of RF signals for a first type of metasurface unit cell; and
a second uniformly-sized resonating main body dimensioned to reflect a second wavelength band of RF signals for a second type of metasurface unit cell so that the metasurface unit cell array may reflect RF signals from the first wavelength band and from the second wavelength band.

6. The information handling system of claim 1 further comprising:
the at least one external surface of the information handling system including an external lid portion of the information handling system.

7. The information handling system of claim 1 further comprising:
each metasurface unit cell including:
an RF signal-permeable cover over the uniformly-sized resonating main body and phase-delay line formed on the dielectric substrate; and
a metal layer formed under the dielectric substrate.

8. A passive metasurface unit cell array comprising:
a plurality of metasurface unit cells having a plurality of resonating structures of conductive material formed on a dielectric substrate layer forming a panel of the passive metasurface unit cell array, each resonating structure including:
a uniformly-sized resonating main body formed on the dielectric substrate and sized uniformly across at least a portion of the plurality of metasurface unit cells; and
a phase-delay line of conductive material formed to extend from the uniformly-sized resonating main body and extending a length from the uniformly-sized resonating main body to introduce a phase shift in RF signals incident on each metasurface unit cell, wherein different-length phase-delay lines are formed among the plurality of metasurface unit cells to generate an interference pattern for constructive or destructive interference in a reflected RF signal reflected off of the surface of the metasurface unit cell array for beamsteering in a radiofrequency environment.

9. The passive metasurface unit cell array of claim 8 further comprising:
each of the uniformly-sized resonating main bodies formed into square metal uniformly-sized resonating main bodies arranged in rows and columns across the metasurface unit cell array.

10. The passive metasurface unit cell array of claim 8, wherein each of the phase-delay lines extend out from the uniformly-sized resonating main body and wraps around a portion of the perimeter of the uniformly-sized resonating main body at different lengths across the metasurface unit cells.

11. The passive metasurface unit cell array of claim 8, wherein the uniformly-sized resonating main body is dimensioned in length and width to reflect a wavelength band of the incident RF signals in the radiofrequency environment.

12. The passive metasurface unit cell array of claim 8 further comprising:
the plurality of metasurface unit cells including:
a first uniformly-sized resonating main body dimensioned to reflect a first wavelength band of RF signals for a first type of metasurface unit cell; and
a second uniformly-sized resonating main body dimensioned to reflect a second wavelength band of RF signals for a second type of metasurface unit cell so that the metasurface unit cell array may reflect RF signals from the first wavelength band and from the second wavelength band.

13. The passive metasurface unit cell array of claim 8 further comprising:
each metasurface unit cell including:
an RF signal-permeable cover over the uniformly-sized resonating main body and phase-delay line formed on the dielectric substrate.

14. An information handling system comprising:
a processor, memory, power source, and a chassis having at least one external surface;
a passive metasurface unit cell array operatively coupled to the at least one external surface of the information handling system for reflecting radiofrequency (RF) signals in a radiofrequency environment comprising:
a plurality of metasurface unit cells, each of the plurality of metasurface unit cells including:
a uniformly-sized resonating main body formed of conductive material deposited on a dielectric substrate and sized uniformly across at least a portion of the plurality of metasurface unit cells; and
a phase-delay line of conductive material formed to extend out from an the uniformly-sized resonating main body and, depending on length of the phase-delay line, wraps around a portion of the perimeter of the uniformly-sized resonating main body at different lengths used across the metasurface unit cells to introduce a phase shift in RF signals incident on the metasurface unit cell,
wherein different-length phase-delay lines are formed among the plurality of metasurface unit cells to generate an interference pattern in a reflected RF signal reflected off of the surface of the metasurface unit cell array for beamsteering in the radiofrequency environment.

15. The information handling system of claim 14 further comprising:
each of the uniformly-sized resonating main bodies formed into square metal uniformly-sized resonating main bodies arranged in rows and columns across the metasurface unit cell array.

16. The information handling system of claim 14 further comprising:
each of the uniformly-sized resonating main bodies formed into rows and columns across the metasurface unit cell array and spaced apart at a spacing distance between the metasurface unit cell array to adjust beamwidth of beamforming for reflected RF signals.

17. The information handling system of claim 14 further comprising:
each of the uniformly-sized resonating main bodies formed into rows and columns across the metasurface unit cell array and asymmetrically spaced apart across the rows or columns of the metasurface unit cell array to generate asymmetric beam shaping of beamforming for reflected RF signals.

18. The information handling system of claim 14, wherein the uniformly-sized resonating main body is dimensioned in length and width to reflect a wavelength band of the incident RF signals in the radiofrequency environment.

19. The information handling system of claim 14 further comprising:
the plurality of metasurface unit cells including:
a first uniformly-sized resonating main body dimensioned to reflect a first wavelength band of RF signals for a first type of metasurface unit cell; and
a second uniformly-sized resonating main body dimensioned to reflect a second wavelength band of RF signals for a second type of metasurface unit cell so that the metasurface unit cell array may reflect RF signals from the first wavelength band and from the second wavelength band.

20. The information handling system of claim 14 further comprising:
each metasurface unit cell including:
an RF signal-permeable cover over the uniformly-sized resonating main body and phase-delay line formed on the dielectric substrate; and
a metal layer formed under the dielectric substrate.
